(19) United States
(12) Patent Application Publication
(10) Pub. No.: US 2026/0136196 A1
(43) Pub. Date: May 14, 2026

(54) Network nodes pairing method having an anti-spoofing mechanism

(71) Applicant: REALTEK SEMICONDUCTOR CORPORATON, HSINCHU (TW)

(72) Inventors: ZHAO-MING LI, Suzhou (CN); CUI DING, Suzhou (CN); MENG-ZHOU SHEN, Suzhou (CN); YI-DONG HE, Suzhou (CN)

(21) Appl. No.: 19/345,586

(22) Filed: Sep. 30, 2025

(30) Foreign Application Priority Data
Nov. 13, 2024 (CN) 202411620720.8

(51) Int. Cl. H04W 12/122; H04W 12/037; H04W 12/041; H04W 12/106; H04W 76/14; H04W 84/20

(52) U.S. Cl. CPC H04W 12/122; H04W 12/037; H04W 12/041; H04W 12/106; H04W 76/14; H04W 84/20

(57) ABSTRACT

A network nodes pairing method having an anti-spoofing mechanism is provided used in a mesh network system. Each of node apparatuses in the mesh network system uses group information of the mesh network system as a key to encrypt network system identification information and self-identification information to broadcast a beacon signal including encrypted information. A scan process is executed by a child node apparatus to select a target father node. A validity verification process is performed on the beacon signal of the target father node according to the group information so as to determine the target father node passes the validity verification process when the target father node and the child node apparatus has the same network system identification information and when the self-identification information of the target father node is valid. A pairing request signal is transmitted to the target father node to request for pairing.

### BACKGROUND OF THE INVENTION

### 1. Field of the Invention

The present invention relates to a network nodes pairing method having an anti-spoofing mechanism.

### 2. Description of Related Art

A mesh network allows the transmission of data or control commands between network nodes by using a dynamic routing method. Such a network keeps the integrity of the connections among the nodes. When some nodes in the network topology malfunction or cannot provide service, a new routing can be formed by using a leaping method to transmit the message to the target node.

However, under the condition that a child node apparatus in the mesh network attempts to switch to be connected with other node apparatuses, if a node apparatus that is from another network fakes to be a father node apparatus within the network that the child node apparatus joins such that the pairing between the child node apparatus and the fake father node is established successfully, the data related to such a child node apparatus cannot be transmitted in the network that the child node apparatus joins.

### SUMMARY OF THE INVENTION

In consideration of the problem of the prior art, an object of the present invention is to supply a network nodes pairing method having an anti-spoofing mechanism.

The present invention discloses a network nodes pairing method having an anti-spoofing mechanism used in a mesh network system that includes steps outlined below. For each of a plurality of node apparatuses in the mesh network system, group information of the mesh network system is set to be a key to encrypt network system identification information of the mesh network system and self-identification information of the node apparatuses to generate encrypted information and further broadcast a beacon signal including the encrypted information. A scan process is executed by a child node apparatus to select a target father node apparatus. A validity verification process is performed on the encrypted information included by the beacon signal from the target father node apparatus according to the group information by the child node apparatus. The target father node apparatus is determined to pass the validity verification process by the child node apparatus when the encrypted information indicates that the target father node apparatus and the child node apparatus have the same network system identification information and when the self-identification information of the target father node apparatus is valid. A pairing request signal is transmitted to the target father node apparatus by the child node apparatus to request for pairing.

These and other objectives of the present invention will no doubt become obvious to those of ordinary skill in the art behind reading the following detailed description of the preferred embodiments that are illustrated in the various figures and drawings.

### BRIEF DESCRIPTION OF THE DRAWINGS

FIG. 1 illustrates a diagram of a mesh network system according to an embodiment of the present invention.

FIG. 2 illustrates a flow chart of a network nodes pairing method having an anti-spoofing mechanism according to an embodiment of the present invention.

FIG. 3 illustrates a diagram of a beacon signal broadcasted by the node apparatus according to an embodiment of the present invention.

FIG. 4 illustrates a timing diagram of the signal transmissions between two node apparatuses according to an embodiment of the present invention.

FIG. 5 illustrates a timing diagram of the signal transmissions between two node apparatuses according to an embodiment of the present invention.

### DETAILED DESCRIPTION OF THE PREFERRED EMBODIMENTS

An aspect of the present invention is to provide a network nodes pairing method having an anti-spoofing mechanism to allow any one of node apparatuses in a mesh network system to broadcast a beacon signal including encrypted information such that other node apparatuses perform a validity verification process on the encrypted information of the beacon signal. The attack performed by external node apparatuses that are spoofed to be internal node apparatuses in the mesh network system can be avoided and the security of the mesh network system can be maintained.

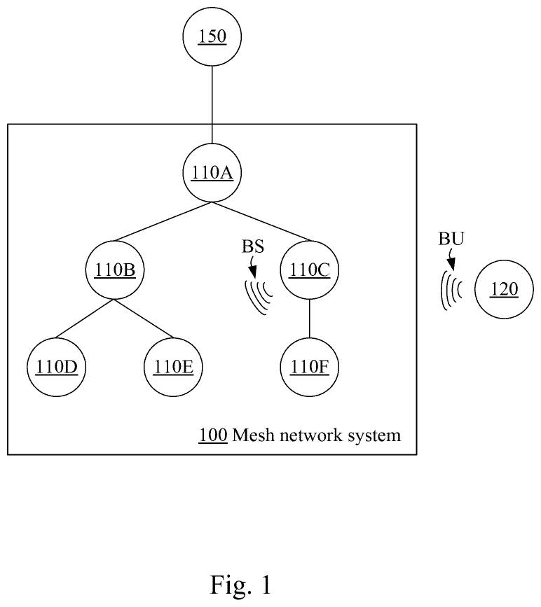

Reference is now made to FIG. 1. FIG. 1 illustrates a diagram of a mesh network system 100 according to an embodiment of the present invention. The mesh network system 100 includes node apparatuses 110A-110F.

The mesh network system 100 is a communication network having a mesh topology that allows the node apparatuses 110A-110F to communication each other. Each of the node apparatuses 110A-110F includes a processing circuit, a communication circuit and a storage circuit (not illustrated) to implement a computing apparatus that has an independent address and is able to transmit and receive data.

The node apparatuses 110A-110F may communicate with an access point apparatus 150, wherein the node apparatus 110A that is directly connected to the access point apparatus 150 is a root node apparatus. The node apparatuses connected to the access point apparatus 150 through the root node apparatus are secondary node apparatuses, e.g., the node apparatus 110B and 110C connected to the node apparatus 110A in FIG. 1. The node apparatuses connected to the access point apparatus 150 through the secondary node apparatuses are tertiary node apparatuses, e.g., the node apparatuses 110D and 110E connected to the node apparatus 110B and the node apparatus 110F connected to the node apparatus 110C illustrated in FIG. 1. It is appreciated that the configuration and the number of the node apparatuses illustrated in FIG. 1 are merely an example. In other embodiments, the node apparatuses may be configured to have more layers. The present invention is not limited thereto.

In the configuration described above, for the node apparatuses at two consecutive layers that are connected, the node apparatus at the previous layer is the father node apparatus of the node apparatus at the subsequent layer, and the node apparatus at the subsequent layer is the child node apparatus of the node apparatus at the previous layer. For example, In FIG. 1, the node apparatus 110B is the father node apparatus of the node apparatus 110D and the node apparatus 110D is the child node apparatus of the node apparatus 110B. Any one of the node apparatuses has only one father node apparatus, while a father node apparatus is allowed to have a plurality of child node apparatuses.

Each of the node apparatuses 110A-110F uses an assistance table stored therein to document the corresponding child node apparatuses and the child node apparatuses of these child node apparatuses. For example, the assistance table of the node apparatus 110B documents the node apparatuses 110D and 110E. The assistance table of the node apparatus 110C documents the node apparatus 110F. The assistance table of the node apparatus 110A documents the node apparatus 110B-110E.

Each of the node apparatuses 110A-110F may document the child node apparatuses by using related information of each of the child node apparatuses, such as but not limited to media access control (MAC) address or a variants thereof (e.g., information generated by performing a hash value calculation or a circular redundancy check (CRC) calculation based on the media access control).

The detail of the network configuration and the establishment of the assistance table can be referred to US patent application US20240015585A1 and is not described herein. The node apparatuses 110A-110F may form the configuration described above according to a pairing process, where the detail of the pairing process can be referred to US patent application US20240015822A1 and is not described herein.

In some usage scenarios, a node apparatus that operates as a child node apparatus may switch to be connected to a new father node apparatus. For example, the node apparatus 110D, by using a pairing switching process, may be disconnected with an original father node apparatus (e.g., the node apparatus 110B) and further set the node apparatus 110C to be a new father node apparatus so as to be connected thereto. The detail of the pairing switching process can be referred to US patent application US20240015821A1 and is not described herein.

However, in some approaches, the information to perform the pairing switching process is public information. External node apparatuses may be spoofed to be the father node apparatuses internal to the mesh network system 100 to perform pairing. The data related to the child node apparatus performing the pairing switching process cannot be transmitted in the mesh network system 100.

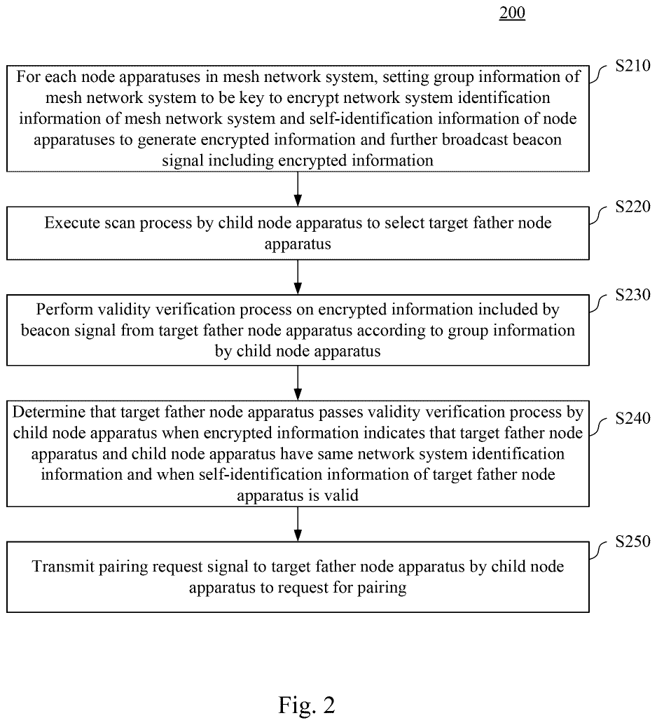

Reference is now made to FIG. 2. FIG. 2 illustrates a flow chart of a network nodes pairing method 200 having an anti-spoofing mechanism according to an embodiment of the present invention. The network nodes pairing method 200 can be used in the mesh network system 100 in FIG. 1 to prevent the child node apparatus from being attacked by the spoofing of the external node apparatuses.

In step S210, for each of the node apparatuses 110A-110F in the mesh network system 100, group information of the mesh network system 100 is set to be a key to encrypt network system identification information of the mesh network system 100 and self-identification information of the node apparatuses to generate encrypted information and further broadcast a beacon signal including the encrypted information.

In an embodiment, the group information of the mesh network system 100 is an access point password provided by the access point apparatus 150, a group key provided by the access point apparatus 150 after connections with the node apparatuses 110A-110F are established or a shared key generated by the node apparatuses 110A-110F according to the access point password by using a predetermined algorithm. The network system identification information of the mesh network system 100 is a basic service set identifier of the access point apparatus 150. The self-identification information of each of the node apparatuses 110A-110 is a media access control address thereof.

In the information described above, the access point password needs to be obtained and stored by the node apparatuses 110A-110F from the access point apparatus 150 before the connections between the node apparatuses 110A-110F and the access point apparatus 150 are established. The group key is provided by the access point apparatus 150 directly or through a relay node apparatus after the connections between the node apparatuses 110A-110F and the access point apparatus 150 are established. The shared key is generated according to the access point password by using the predetermined algorithm by the node apparatuses 110A-110F that already join the mesh network system 100 and become the connected node apparatuses or by unconnected node apparatuses that have not joined the mesh network system 100 but already obtain the access point password.

The predetermined algorithm is either a standard key derivation algorithm that belongs to a key derivation function (KDF) algorithm or a non-standard key derivation algorithm. The basic service set identifier is disposed in the beacon signal by the access point apparatus 150 so as to be broadcasted and obtained by the node apparatuses 110A-110F such that the node apparatuses 110A-110F store the basic service set identifier.

Take the node apparatus 110C as an example, the node apparatus 110C may encrypt the basic service set identifier of the access point apparatus 150 and the media access control address of the node apparatus 110C, according to the group key provided by the access point apparatus 150 or the shared key generated according to access point password by using the key derivation function algorithm, to generate the encrypted information.

The node apparatuses 110A-110F may use such as, but not limited to an advanced encryption standard (AES) encryption algorithm, a data encryption standard (DES) encryption algorithm or a RSA encryption algorithm to perform encryption to generate the encrypted information.

In different embodiments, the node apparatuses 110A-110F may generate the encrypted information of different contents depending on the requirements. For example, the encrypted information may include a full string generated by encrypting the network system identification information and the self-identification information, or may include partial string generated by encrypting the network system identification information and the self-identification information.

It is appreciated that in other embodiments, the node apparatuses 110A-110F may generate the encrypted information according to other formats of group information or other formats of self-identification information by using other encryption algorithms. The present invention is not limited thereto.

Each of the node apparatuses 110A-110F further broadcasts the beacon signal BS including the encrypted information. It is appreciated that, each of the node apparatuses in the mesh network system 100 may perform the operation described above and generate the beacon signal respectively. In FIG. 1, only the beacon signal BS generated by the node apparatus 110C is exemplarily illustrated.

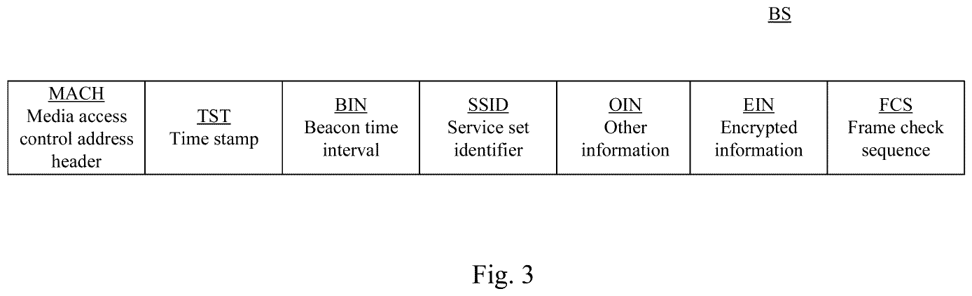

Reference is now made to FIG. 3 at the same time. FIG. 3 illustrates a diagram of a beacon signal BS broadcasted by the node apparatus 110C according to an embodiment of the present invention.

As illustrated in FIG. 3, the beacon signal BS includes a plurality of entries to document the content of a media access control address header MACH, a time stamp TST, a beacon time interval BIN, a service set identifier SSID, an other information element OIN, encrypted information EIN, and a frame check sequence FCS. The number of the other information element OIN can be one or more than one, where each of the other information element OIN and the encrypted information EIN may be documented by an entry corresponding to an information element (IE).

It is appreciated that the packet configuration of the beacon signal BS described above is merely an example. In other embodiments, the beacon signal BS may include contents of other entries depending on practical requirements. The present invention is not limited thereto.

In step S220, a scan process is executed by a child node apparatus to select a target father node apparatus.

In an embodiment, the child node apparatus is one of the node apparatuses 110A-110F, i.e., a connected node apparatus that establishes the connection with the access point apparatus 150 and is connected to a current father node apparatus before the scan process is performed. Take the condition that the node apparatus 110E is the child node apparatus of the node apparatus 110B and the node apparatus 110B is the current father node apparatus of the node apparatus 110E as an example, when the node apparatus 110E determines to be not connected to the node apparatus 110B anymore after a certain criteria is satisfied, the node apparatus 110E performs the scan process and select such as, but not limited to the node apparatus 110C as a target father node apparatus.

In step S230, a validity verification process is performed on the encrypted information included by the beacon signal from the target father node apparatus according to the group information by the child node apparatus.

In step S240, the target father node apparatus is determined to pass the validity verification process by the child node apparatus when the encrypted information indicates that the target father node apparatus and the child node apparatus have the same network system identification information and when the self-identification information of the target father node apparatus is valid.

According to the example described above, the node apparatus 110E performs the validity verification process on the encrypted information included in the beacon signal BS from the node apparatus 110C according to the group information. Based on different contents included by encrypted information, the performing of the validity verification process is different.

Take the condition that the node apparatus 110E selects the node apparatus 110C to be the target father node apparatus after the scan process as an example, when the encrypted information includes the full string generated by encrypting the network system identification information and the self-identification information, the child node apparatus (i.e., the node apparatus 110E) decrypts the encrypted information according to the group information that the child node apparatus has to generate a plain text content.

The child node apparatus first determines whether plain text network system identification information included by the plain text content (i.e., the basic service set identifier of the access point apparatus 150 generated after the decryption) and the network system identification information included by the child node apparatus (i.e., the basic service set identifier of the access point apparatus 150 stored in the node apparatus 110E) are the same.

Subsequently, the child node apparatus determines whether plain text self-identification information included by the plain text content (i.e., the media access control address or the variant thereof of the node apparatus 110C generated after the decryption) and the self-identification information (i.e., the media access control address or the variant thereof of the node apparatus 110C) documented in a self-identification information entry of the beacon signal BS from the target father node apparatus (i.e., the node apparatus 110C) are the same

When the plain text network system identification information and the network system identification information are the same and when the plain text self-identification information and the self-identification information documented in the beacon signal are the same, the encrypted information indicates that the target father node apparatus and the child node apparatus have the same network system identification information and the self-identification information of the target father node apparatus is correct. The child node apparatus thus determines that the target father node apparatus passes the validity verification process. When any one of the results of the determination is different, the child node apparatus determines that such a target father node apparatus does not pass the validity verification process.

When the encrypted information includes the partial string generated by encrypting the network system identification information and the self-identification information, the child node apparatus (i.e., the node apparatus 110E) encrypts the network system identification information included by the child node apparatus ((i.e., the basic service set identifier of the access point apparatus 150 stored in the node apparatus 110E) and the self-identification information documented in the self-identification information entry of the beacon signal BS from the target father node apparatus (i.e., the node apparatus 110C) according to the group information that the child node apparatus has to generate a cipher text content.

When a corresponding partial content of the cipher text content (i.e., the content corresponding to the partial string) matches the encrypted information, the encrypted information indicates that the target father node apparatus and the child node apparatus have the same network system identification information and the self-identification information of the target father node apparatus is correct. The child node apparatus thus determines that the target father node apparatus passes the validity verification process. When the corresponding partial content of the cipher text content does not match the encrypted information, the child node apparatus determines that such a target father node apparatus does not passes the validity verification process.

In step S250, the pairing request signal is transmitted to the target father node apparatus by the child node apparatus to request for pairing.

In an embodiment, when the child node apparatus is a connected node apparatus that is one of the node apparatuses 110A-110F, the child node apparatus disconnects from the current father node apparatus to further transmit the pairing request signal. Based on the example described above, after determining that the node apparatus 110C passes the validity verification process, the node apparatus 110E disconnects from the node apparatus 110B and transmits the pairing request signal to the node apparatus 110C.

On the other hand, when the target father node apparatus is determined to not passes the validity verification process after step S230, the child node apparatus does not transmit the pairing request signal to such a target father node apparatus. Under such a condition, the child node apparatus may select another target father node apparatus according to the previous scan result or perform the scan process again and select another target father node apparatus to perform the validity verification process.

In an embodiment, each of the node apparatuses 110A-110F in the mesh network system 100 may perform the validity verification process in step S230 on the encrypted information included by the beacon signal BU from a specific node apparatus 120. Such a specific node apparatus 120 can be either any one of the node apparatuses in the mesh network system 100 or a node apparatus external to the mesh network system 100.

When the encrypted information included by the beacon signal BU from the specific node apparatus 120 passes the validity verification process, the node apparatuses 110A-110F treat such a specific node apparatus to be a valid node apparatus internal to the network. However, when the encrypted information included by the beacon signal BU from the specific node apparatus 120 does not passes the validity verification process, the node apparatuses 110A-110F in the mesh network system 100 mark such a specific node apparatus to be a spoofing node apparatus.

It is appreciated that the validity verification process described above can be performed in any two of the node apparatuses 110A-110F.

Based on the validity verification process performed when each two of the node apparatuses exchange the beacon signals, the target father node apparatus may determine whether an under-pairing child node apparatus is the spoofing node apparatus when the target father node apparatus receives the pairing request signal from the under-pairing child node apparatus. The target father node apparatus does not transmit a pairing permitting signal to the under-pairing child node apparatus by the target father node apparatus when the under-pairing child node apparatus is determined to be the spoofing node apparatus.

Besides, the target father node apparatus transmits the pairing permitting signal to the under-pairing child node apparatus when the under-pairing child node apparatus is determined to be not the spoofing node apparatus and when the target father node apparatus is determined to be able to provide the under-pairing child node apparatus a relay service. The subsequent pairing process can be referred to US patent application US20240015822A1 and is not described herein.

As a result, the network nodes pairing method having the anti-spoofing mechanism in the present invention allows any one of node apparatuses in a mesh network system to broadcast a beacon signal including encrypted information such that other node apparatuses perform a validity verification process on the encrypted information of the beacon signal. The attack from external node apparatuses that are spoofed to be internal node apparatuses in the mesh network system can be avoided and the security of the mesh network system can be maintained.

It is appreciated that in the example described above, the condition that the child node apparatus is a connected node apparatus that is one of the node apparatuses 110A-110F that performs the father node apparatus switching as an example. Under such a condition, the connected node apparatus can use either the group key provided by the access point apparatus 150 after the connections with the node apparatuses 110A-110F are established or the shared key generated by the node apparatuses 110A-110F according to the access point password by using the predetermined algorithm to perform the validity verification process.

In some embodiments, the child node apparatus can be an unconnected node apparatus that is not connected to the mesh network system 100. Under such a condition, the group key provided by the access point apparatus 150 after the connections with the node apparatuses 110A-110F are established can only be used by the connected node apparatus and cannot be used by the unconnected node apparatus to perform the validity verification process.

In other words, the unconnected node apparatus can only obtain the access point password from the access point apparatus 150 to use the shared key generated by using the predetermined algorithm to perform the validity verification process. The unconnected node apparatus cannot obtain the group key provided by the access point apparatus 150 under the unconnected state to perform the validity verification process. Only after the unconnected node apparatus finishes being connected to the mesh network system 100 to become the connected node apparatus, such a connected node apparatus can select either the group key or the shared key to perform the validity verification process.

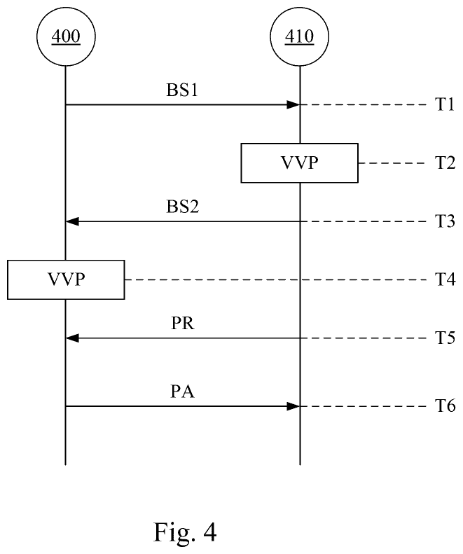

Reference is now made to FIG. 4. FIG. 4 illustrates a timing diagram of the signal transmissions between two node apparatuses 400 and 410 according to an embodiment of the present invention.

Each of the node apparatus 400 and the node apparatus 410 can be one of the internal node apparatuses in the mesh network system 100 in FIG. 1 or can be an external node apparatus outside of the mesh network system 100. A usage scenario of the operation of the anti-spoofing mechanism is described by using the signal transmissions between node apparatus 400 and the node apparatus 410 as an example.

At a time spot T1, the node apparatus 400 broadcasts a beacon signal BS1 including the encrypted information to be received by the node apparatus 410.

At a time spot T2, the node apparatus 410 performs the validity verification process (abbreviated as VVP in FIG. 4) on the encrypted information of the beacon signal BS1.

At a time spot T3, the node apparatus 410 broadcasts a beacon signal BS2 including the encrypted information to be received by the node apparatus 400.

At a time spot T4, the node apparatus 400 performs the validity verification process on the encrypted information of the beacon signal BS2.

At a time spot T5, the node apparatus 410 select the node apparatus 400 to be the target father node apparatus. When the node apparatus 410 determines that the encrypted information of the beacon signal BS1 does not passes the validity verification process, the node apparatus 410 does not transmit a pairing request signal PR to the node apparatus 400. Instead, when the node apparatus 410 determines that the encrypted information of the beacon signal BS1 passes the validity verification process, the node apparatus 410 transmits the pairing request signal PR to the node apparatus 400 to perform pairing.

At a time spot T6, when the node apparatus 400 receives the pairing request signal PR, determines that the node apparatus 410 is an under-pairing child node apparatus and determines that the encrypted information of the beacon signal BS1 does not passes the validity verification process, the node apparatus 400 determines that the node apparatus 410 is a spoofing node apparatus and does not transmit a pairing permitting signal PA to the node apparatus 410. In an embodiment, the node apparatus 400 may transmit a pairing failing signal (not illustrated) to the node apparatus 410 when the pairing permitting signal PA is not transmitted to inform the request of the pairing request signal PR is denied.

When the node apparatus 400 receives the pairing request signal PR, determines that the node apparatus 410 is an under-pairing child node apparatus and determines that the encrypted information of the beacon signal BS1 passes the validity verification process, the node apparatus 400 determines that the node apparatus 410 is not a spoofing node apparatus and transmits the pairing permitting signal PA to the node apparatus 410.

In the example describe above, some of the operations at the time spots T1-T4 may be partially executed at the same time or may be executed in different orders without following the order illustrated in FIG. 4 under the condition that the result is not affected. For example, the broadcasting of the beacon signals of different node apparatuses at the time spots T1 and T3 may have different orders. The validity verification process performed by the node apparatus 410 at the time spot T2 can be performed in any reasonable range of time after the time spot T1. The validity verification process performed by the node apparatus 400 at the time spot T4 can be performed in any reasonable range of time after the time spot T3.

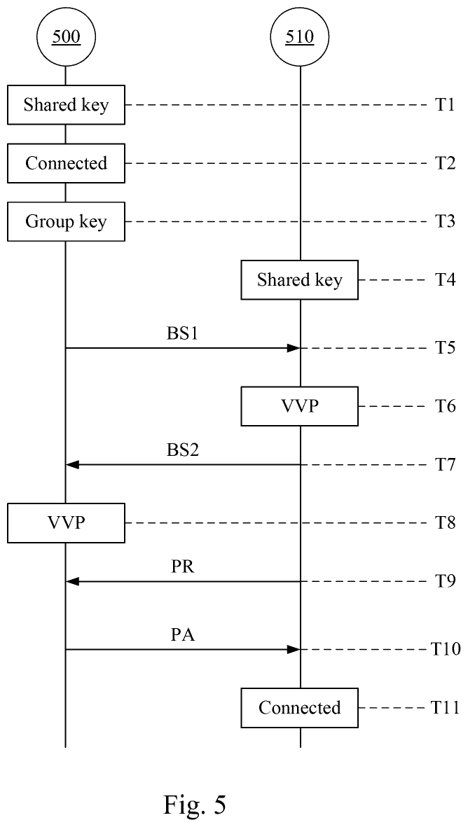

Reference is now made to FIG. 5. FIG. 5 illustrates a timing diagram of the signal transmissions between two node apparatuses 500 and 510 according to an embodiment of the present invention.

The condition that each of the node apparatus 500 and the node apparatus 510 already obtains the access point password is used to describe a usage scenario of the operation of the anti-spoofing mechanism using the signal transmissions between node apparatus 500 and the node apparatus 510 as an example.

At a time spot T1, the node apparatus 500 generates a shared key according to the access point password.

At a time spot T2, the node apparatus 500 joins the mesh network system 100 (and establishes a connection with such as the access point apparatus 150 in FIG. 1) to become a connected node apparatus.

At a time spot T3, the node apparatus 500 receives the group key.

At a time spot T4, the node apparatus 510 generates the shared key according to access point password.

At a time spot T5, the node apparatus 500 broadcasts the beacon signal BS1 including the encrypted information to be received by the node apparatus 510.

At a time spot T6, the node apparatus 510 performs the validity verification process on the encrypted information of the beacon signal BS1. Under such a condition, since the node apparatus 510 is still an unconnected node apparatus, only the shared key can be used to perform the validity verification process.

At a time spot T7, the node apparatus 510 broadcasts a beacon signal BS2 including the encrypted information to be received by the node apparatus 500.

At a time spot T8, the node apparatus 500 performs the validity verification process on the encrypted information of the beacon signal BS2. Since the node apparatus 500 is the connected node apparatus, either the shared key or the group key can be used to perform the validity verification process.

At a time spot T9, the node apparatus 510 selects the node apparatus 500 to be the target father node apparatus. When the node apparatus 510 determines that the encrypted information of the beacon signal BS1 does not passes the validity verification process, the node apparatus 510 does not transmit the pairing request signal PR to the node apparatus 500. When the node apparatus 510 determines that the encrypted information of the beacon signal BS1 passes the validity verification process, the node apparatus 510 transmits the pairing request signal PR to the node apparatus 500 to perform pairing.

At a time spot T10, when the node apparatus 500 receives the pairing request signal PR, determines that the node apparatus 510 is an under-pairing child node apparatus and determines that the encrypted information of the beacon signal BS1 does not pass the validity verification process, the node apparatus 500 determines that the node apparatus 510 is a spoofing node apparatus and does not transmit the pairing permitting signal PA to the node apparatus 510. In an embodiment, the node apparatus 500 may transmit a pairing failing signal (not illustrated) to the node apparatus 510 when the pairing permitting signal PA is not transmitted to inform the request of the pairing request signal PR is denied.

When the node apparatus 500 receives the pairing request signal PR, determines that the node apparatus 510 is an under-pairing child node apparatus and determines that the encrypted information of the beacon signal BS1 passes the validity verification process, the node apparatus 500 determines that the node apparatus 510 is not a spoofing node apparatus and transits the pairing permitting signal PA to the node apparatus 510. The node apparatus 510 joins the mesh network system 100 (and establishes a connection with such as the access point apparatus 150 in FIG. 1) to become a connected node apparatus under the assistance of the node apparatus 500.

At a time spot T11, the node apparatus 510 receives the group key. Under such a condition, since the node apparatus 510 is the connected node apparatus, either the shared key or the group key can be used when the validity verification process is to be performed.

Similarly, in the example describe above, some of the operations at the time spots T1-T8 may be partially executed at the same time or may be executed in different orders without following the order illustrated in FIG. 5 under the condition that the result is not affected.

It is appreciated that the embodiments described above are merely an example. In other embodiments, it should be appreciated that many modifications and changes may be made by those of ordinary skill in the art without departing, from the spirit of the disclosure.

In summary, the present invention discloses the network nodes pairing method having an anti-spoofing mechanism to allow any one of node apparatuses in a mesh network system to broadcast a beacon signal including encrypted information such that other node apparatuses perform a validity verification process on the encrypted information of the beacon signal. The attack performed by external node apparatuses that are spoofed to be internal node apparatuses in the mesh network system can be avoided and the security of the mesh network system can be maintained.

The aforementioned descriptions represent merely the preferred embodiments of the present invention, without any intention to limit the scope of the present invention thereto. Various equivalent changes, alterations, or modifications based on the claims of present invention are all consequently viewed as being embraced by the scope of the present invention.

What is claimed is:

1. A network nodes pairing method having an anti-spoofing mechanism used in a mesh network system, comprising:
for each of a plurality of node apparatuses in the mesh network system, setting group information of the mesh network system to be a key to encrypt network system identification information of the mesh network system and self-identification information of the node apparatuses to generate encrypted information and further broadcast a beacon signal comprising the encrypted information;
executing a scan process by a child node apparatus to select a target father node apparatus;
performing a validity verification process on the encrypted information comprised by the beacon signal from the target father node apparatus according to the group information by the child node apparatus;
determining that the target father node apparatus passes the validity verification process by the child node apparatus when the encrypted information indicates that the target father node apparatus and the child node apparatus have the same network system identification information and when the self-identification information of the target father node apparatus is valid; and
transmitting a pairing request signal to the target father node apparatus by the child node apparatus to request for pairing.

2. The network nodes pairing method of claim 1, wherein the child node apparatus is one of the plurality of node apparatuses and is connected to a current father node apparatus before the scan process is performed, and the network nodes pairing method further comprises:
disconnecting from the current father node apparatus by the child node apparatus to further transmit the pairing request signal when the target father node apparatus is determined to pass the validity verification process.

3. The network nodes pairing method of claim 1, wherein the encrypted information comprises a full string generated by encrypting the network system identification information and the self-identification information, the validity verification process performed by the child node apparatus comprises:
decrypting the encrypted information according to the group information that the child node apparatus has to generate a plain text content; and
determining that the target father node apparatus passes the validity verification process when plain text network system identification information comprised by the plain text content and the network system identification information comprised by the child node apparatus are the same and when plain text self-identification information comprised by the plain text content and the self-identification information documented in a self-identification information entry of the beacon signal from the target father node apparatus are the same.

4. The network nodes pairing method of claim 1, wherein the encrypted information comprises a partial string generated by encrypting the network system identification information and the self-identification information, the validity verification process performed by the child node apparatus comprises:
encrypting the network system identification information comprised by the child node apparatus and the self-identification information documented in a self-identification information entry of the beacon signal from the target father node apparatus according to the group information that the child node apparatus has to generate a cipher text content; and
determining that the target father node apparatus passes the validity verification process when a corresponding partial content matches the encrypted information.

5. The network nodes pairing method of claim 1, further comprising:
performing the validity verification process on the encrypted information comprised by the beacon signal from a specific node apparatus by each of the plurality of node apparatuses;
marking the specific node apparatus to be spoofing node apparatus when the encrypted information comprised by the beacon signal from the specific node apparatus does not pass the validity verification process;
determining whether an under-pairing child node apparatus is the spoofing node apparatus by the target father node apparatus when the target father node apparatus receives the pairing request signal from the under-pairing child node apparatus; and
not transmitting a pairing permitting signal to the under-pairing child node apparatus by the target father node apparatus when the under-pairing child node apparatus is determined to be the spoofing node apparatus.

6. The network nodes pairing method of claim 5, further comprising:
transmitting the pairing permitting signal to the under-pairing child node apparatus by the target father node apparatus when the under-pairing child node apparatus is determined to be not the spoofing node apparatus and when the target father node apparatus is determined to be able to provide the under-pairing child node apparatus a relay service.

7. The network nodes pairing method of claim 1, wherein the plurality of node apparatuses group information is an access point password provided by an access point apparatus that the plurality of node apparatuses correspond to, a group key provided by the access point apparatus after connections with the plurality of node apparatuses are established or a shared key generated by the plurality of node apparatuses according to the access point password by using a predetermined algorithm;
wherein the predetermined algorithm is a standard key derivation algorithm that belongs to a key derivation function (KDF) algorithm or a non-standard key derivation algorithm.

8. The network nodes pairing method of claim 7, wherein the shared key is allowed to be used by a connected node apparatus in the plurality of node apparatuses and an unconnected node apparatus not in the plurality of node apparatuses to perform the validity verification process, and the group key is only allowed to be used by the connected node apparatus to perform the validity verification process.

9. The network nodes pairing method of claim 7, further comprising:
only using the group key to perform the validity verification process by an unconnected node apparatus that is not in the plurality of node apparatuses and
selectively using the group key or the shared key to perform the validity verification process by the unconnected node apparatus and a connected node apparatus in the plurality of node apparatuses.

10. The network nodes pairing method of claim 1, wherein the network system identification information is a basic service set identifier (BSSID) of an access point apparatus that the plurality of node apparatuses correspond to.

11. The network nodes pairing method of claim 1, wherein the self-identification information of the node apparatuses is a media access control (MAC) address.

12. The network nodes pairing method of claim 1, further comprising:
for each of the plurality of node apparatuses, generating the encrypted information by using an advanced encryption standard (AES) encryption algorithm, a data encryption standard (DES) encryption algorithm or a RSA encryption algorithm.
